(19) United States
(12) Patent Application Publication
(10) Pub. No.: US 2014/0269628 A1
(43) Pub. Date: Sep. 18, 2014

(54) METHOD, APPARATUS, AND COMPUTER PROGRAM PRODUCT FOR OVERLAPPING BSS COORDINATION OF MACRO/PICO WI-FI NETWORKS

(71) Applicant: NOKIA CORPORATION, Espoo (FI)

(72) Inventors: Chittabrata GHOSH, Freemont, CA (US); Klaus Franz DOPPLER, Albany, CA (US); Esa TUOMAALA, Berkeley, CA (US)

(73) Assignee: NOKIA CORPORATION, Espoo (FI)

(21) Appl. No.: 13/798,872

(22) Filed: Mar. 13, 2013

(51) Int. Cl. H04W 74/04

(52) U.S. Cl. CPC H04W 74/04
USPC 370/336

(57) ABSTRACT

Embodiments of the invention provide signaling mechanisms for wireless networks composed of a large number of stations. An example method embodiment comprises: receiving, by an access node of an access network, a frame from an overlapped access network, indicating time restrictions for reserving a wireless medium for the access network; and coordinating, by the access node of the access network, transmissions by members of the access network, to comply with the time restrictions for reserving the wireless medium for the access network.

### FIELD

The field of technology relates to wireless communication and more particularly to signaling mechanisms for wireless networks composed of a large number of stations.

### BACKGROUND

Modern society has adopted, and is becoming reliant upon, wireless communication devices for various purposes, such as connecting users of the wireless communication devices with other users. Wireless communication devices may vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments are disclosed for overlapping wireless networks including a number of hidden stations.

An example embodiment of the invention includes a method comprising:

receiving, by an access node of an access network, a frame from an overlapped access network, indicating time restrictions for reserving a wireless medium for the access network; and

coordinating, by the access node of the access network, transmissions by members of the access network, to comply with the time restrictions for reserving the wireless medium for the access network.

An example embodiment of the invention includes a method comprising:

wherein the access network and the overlapped access network are both basic service sets and the access node is an access point.

An example embodiment of the invention includes a method comprising:

wherein the access network is a short range network and the overlapped access network is a long range network.

An example embodiment of the invention includes a method comprising:

wherein the frame further indicates time restrictions for reserving the wireless medium for at least one of the overlapped access network and a third access network.

An example embodiment of the invention includes a method comprising:

wherein reserving the wireless medium comprises reserving the wireless medium for one of a restricted access window for a subset of stations in the access network or a periodic restricted access window for a subset of stations in the access network.

An example embodiment of the invention includes a method comprising:

wherein the frame is one of a broadcast clear-to-send frame or a broadcast clear-to-send coordination frame.

An example embodiment of the invention includes a method comprising:

wherein the access node changes its beacon transmission time for its beacon to be transmitted outside of the time restriction.

An example embodiment of the invention includes a method comprising:

receiving, by an access node of an access network, two or more frames from overlapped access networks; and

transmitting, by the access node of the access network, a time coordination frame, indicating time restrictions for reserving a wireless medium for the overlapped access networks.

An example embodiment of the invention includes a method comprising:

wherein the access network and the overlapped access networks are basic service sets and the access node is an access point.

An example embodiment of the invention includes a method comprising:

wherein the access network is a long range network and the overlapped access networks are short range networks.

An example embodiment of the invention includes a method comprising:

wherein the frame further indicates time restrictions for reserving the wireless medium for the access network.

An example embodiment of the invention includes a method comprising:

wherein reserving the wireless medium comprises reserving the wireless medium for a restricted access window for a subset of sensor networks.

An example embodiment of the invention includes a method comprising:

wherein the received frame is a broadcast clear-to-send frame.

An example embodiment of the invention includes a method comprising:

wherein the transmitted time coordination frame is a broadcast clear-to-send frame.

An example embodiment of the invention includes an apparatus comprising:

at least one processor;

at least one memory including computer program code;

the at least one memory and the computer program code configured to, with the at least one processor, cause the apparatus at least to:

receive a frame from an overlapped access network, indicating time restrictions for reserving a wireless medium for an access network of the apparatus; and

coordinate transmissions by members of the access network, to comply with the time restrictions for reserving the wireless medium for the access network.

An example embodiment of the invention includes an apparatus comprising:

wherein the access network and the overlapped access network are both basic service sets and the access node is an access point.

An example embodiment of the invention includes an apparatus comprising:

wherein the access network is a short range network and the overlapped access network is a long range network.

An example embodiment of the invention includes an apparatus comprising:

at least one processor;

at least one memory including computer program code;

the at least one memory and the computer program code configured to, with the at least one processor, cause the apparatus at least to:

receive two or more frames from overlapped access networks; and

transmit a time coordination frame, indicating time restrictions for reserving a wireless medium for the overlapped access networks.

An example embodiment of the invention includes a computer program product comprising computer executable program code recorded on a computer readable, non-transitory storage medium, the computer executable program code comprising:

code for receiving, by an access node of an access network, a frame from an overlapped access network, indicating time restrictions for reserving a wireless medium for the access network; and

code for coordinating, by the access node of the access network, transmissions by members of the access network, to comply with the time restrictions for reserving the wireless medium for the access network.

An example embodiment of the invention includes a computer program product comprising computer executable program code recorded on a computer readable, non-transitory storage medium, the computer executable program code comprising:

code for receiving, by an access node of an access network, two or more frames from overlapped access networks; and

transmitting, by the access node of the access network, a time coordination frame, indicating time restrictions for reserving a wireless medium for the overlapped access networks.

The resulting example embodiments provide signaling mechanisms for overlapping wireless networks including a number of hidden stations.

### DESCRIPTION OF THE FIGURES

FIG. 1 is an example Coexistence scenario among long-range and short-range IEEE 802.11ah networks in a scenario of overlapping BSSs, according to an example embodiment of the invention.

FIG. 2 is an example typical scenario of packet collision due to overlapping networks operating on the same channel.

FIG. 3 is an example MAC header frame format of the B-CTS transmission time coordination frame, according to an example embodiment of the invention.

FIG. 4A is an example network diagram of a long-range IEEE 802.11ah network and two short-range IEEE 802.11ah networks that overlap the long-range network. The figure shows the long-range access point of the long range network, monitoring the beacons from the short-range access points. Similarly, the short-range access points of the short range networks, may monitor the beacon from the long range network, according to an example embodiment of the invention.

FIG. 4B is an example network diagram of the long-range IEEE 802.11ah network and the two overlapping short-range IEEE 802.11ah networks of FIG. 4A. The figure shows the long-range access point transmitting a beacon indicating the beginning instant T1 and the ending instant T2 of a first quiet interval. The first quiet interval may be for the short-range stations associated with the short-range access points in the two overlapping short-range networks, according to an example embodiment of the invention.

FIG. 4C is an example network diagram of the long-range IEEE 802.11ah network and the two overlapping short-range IEEE 802.11ah networks of FIG. 4B. The figure shows the two short-range access points transmitting beacons, at their respective target beacon transmission times, scheduling the beginning instant T1 and the ending instant T2 of the first quiet interval. The two short-range access points are further scheduling restricted access windows (RAWs) or periodic restricted access windows (PRAW) of multiple time slots for uplink data transmissions and downlink data transmissions, according to an example embodiment of the invention. The long range access point may transmit beacons with RAW and PRAW. Instead of explicit frames, the short range networks may also use the silent intervals in the beacon frame of the long range network to coordinate the transmissions in the short range network.

FIG. 4D is an example network diagram of the long-range IEEE 802.11ah network and the two overlapping short-range IEEE 802.11ah networks of FIG. 4C. The figure shows two or more of the short-range access points transmitting a broadcast clear-to-send control frame (B-CTS). The broadcast clear-to-send control frame (B-CTS) may be notifying the long-range access point of a second quiet interval for the long-range sensor stations associated with the long-range access point. In accordance with the invention, the long-range access point determines that it may be beneficial to coordinate the timing of the B-CTS to be sent by the short-range access points, according to an example embodiment of the invention.

FIG. 4E is an example network diagram of the long-range IEEE 802.11ah network and the two overlapping short-range IEEE 802.11ah networks of FIG. 4D. The figure shows the long-range access point sending a B-CTS transmission time coordination frame to the short range access points. The B-CTS transmission time coordination frame may be allocating a first coordinated quiet interval to the first overlapping short-range network and allocating a second coordinated quiet interval to the second overlapping short-range network, according to an example embodiment of the invention. In an example embodiment of the invention, the long-range access point may send individual B-CTS transmission time coordination frames to the short range access points in both overlapping short-range networks.

FIG. 4F is an example network diagram of the long-range IEEE 802.11ah network and the two overlapping short-range IEEE 802.11ah networks of FIG. 4E. The figure shows the first overlapping short-range network exchanging traffic during the first coordinated quiet interval, according to an example embodiment of the invention.

FIG. 4G is an example network diagram of the long-range IEEE 802.11ah network and the two overlapping short-range IEEE 802.11ah networks of FIG. 4F. The figure shows the second overlapping short-range network exchanging traffic during the second coordinated quiet interval, according to an example embodiment of the invention. In an example embodiment of the invention, the first and second quiet intervals may be the same, for example where the short range networks operate at the same time since they may not interfere with each other.

FIG. 5 is an example flow diagram of operational steps in the wireless short-range access point device, according to an example embodiment of the invention.

FIG. 6 is an example flow diagram of operational steps in the wireless long-range access point device, according to an example embodiment of the invention.

FIG. 7 is an example functional block diagram, illustrating an example short-range or long-range station device, according to an example embodiment of the invention.

FIG. 8 is an example functional block diagram, illustrating an example short-range or long-range access point device, according to an example embodiment of the invention.

FIG. 9 illustrates an example embodiment of the invention, wherein examples of removable storage media are shown. The removable storage media are based on magnetic, electronic and/or optical technologies, such as magnetic disks, optical disks, semiconductor memory circuit devices and micro-SD memory cards (SD refers to the Secure Digital standard). The removable storage media are for storing data and/or computer program code as an example computer program product, in accordance with at least one embodiment of the present invention.

### DISCUSSION OF EXAMPLE EMBODIMENTS OF THE INVENTION

This section is organized into the following topics:

A. WLAN Communication Technology

B. Overlapping BSS Coordination Of Macro/Pico Wi-Fi Networks

A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j protocols, into the base standard IEEE 802.11-2007, Wireless Medium Access Control (MAC) and Physical Layer (PHY) Specifications, June 2007 (incorporated herein by reference). Since then, emerging broadband applications have stimulated interest in developing very high-speed wireless networks for short-range communication, for example, the IEEE 802.11n, the planned IEEE 802.11 ac, and the planned IEEE 802.11 ad WLAN specifications that are to provide a very high throughput in higher frequency bands. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11ah WLAN standard is being developed for operation below 1 GHz and will have a greater range and lower obstruction losses due to its longer wavelength.

According to an example embodiment, an IEEE 802.11 WLAN may be organized as an independent basic service set (IBSS) or an infrastructure basic service set (BSS). The access point (AP) in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point (AP) in an Infrastructure BSS may bridge traffic out of the BSS onto a distribution network. STAs that are members of the BSS may exchange packets with the AP.

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request to Send (RTS) and the receiver may respond with a Clear to Send (CTS). The channel may be cleared by these two messages, since all STAs that hear at least one of the CTS and the CTS may suppress their own start of a transmission. The Request to Send (RTS) packet sent by the sender and the Clear to Send (CTS) packet sent in reply by the intended receiver, may alert all other devices within range of the sender or the receiver, to refrain from transmitting for the duration of the main packet.

According to an example embodiment, when data packets are transmitted, each may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium may be busy. Use of the NAV for carrier sensing is called virtual carrier sensing. STAs receiving a valid frame may update their NAV with the information received in the duration field for all frames where the new NAV value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a NAV value of zero, to release the channel.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel may be busy. A carrier sensing scheme may be used wherein a node wishing to transmit data has to first listen to the channel for a predetermined amount of time to determine whether or not another node may be transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm may be the truncated binary exponential backoff, wherein after a certain number of increases, the transmission timeout reaches a ceiling and thereafter does not increase any further.

According to an example embodiment, it may also be possible to start data transmission directly without RTS-CTS signaling and in that case, the first packet carries information similar to the RTS to start protection.

According to an example embodiment, an IEEE 802.11 WLAN may also be organized as an independent basic service set (IBSS). Wireless devices in an independent basic service set (IBSS) communicate directly with one another and there is no access point in the IBSS. WLAN ad hoc networks have an independent configuration where the terminal devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format may be identical to that of an IEEE 48-bit address. In an ad hoc network, the BSSID may be a locally administered, individual address that is generated randomly by the device that starts the ad hoc network.

Synchronization is the process of the devices in an ad hoc network getting in step with each other, so that reliable communication may be possible. The MAC may provide the synchronization mechanism to allow support of physical layers that make use of frequency hopping or other time-based mechanisms where the parameters of the physical layer change with time. The process may involve beaconing to announce the presence of an ad hoc network, and inquiring to find an ad hoc network. Once an ad hoc network is found, a device may join the ad hoc network. This process may be entirely distributed in ad hoc networks, and may rely on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

Since there is no AP, the terminal device that starts the ad hoc network may begin by resetting its TSF timer to zero and transmitting a beacon, choosing a beacon period. This establishes the basic beaconing process for this ad hoc network. After the ad hoc network has been established, each device in the ad hoc network will attempt to send a beacon after the target beacon transmission time (TBTT) arrives. To minimize actual collisions of the transmitted beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process may be a purely local process that occurs entirely internal to the terminal device. There may be no indication to the outside world that a device has joined a particular ad hoc network. Joining an ad hoc network may require that all of the terminal device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the terminal device has joined the ad hoc network and may be ready to begin communicating with the devices in the ad hoc network.

A terminal device may associate or register with an access point to gain access to the network managed by the access point. Association allows the access point to record each terminal device in its network so that frames may be properly delivered. After the terminal device authenticates to the access point, it sends an association request to the access point. Association allows the access point to record each terminal device so that frames may be properly delivered. The association request is a management frame that contains information describing the terminal device, such as its capability, listening interval, SSID, supported rates, power capability, QoS capability, and the like. The access point processes the association request and grants association by replying with an association response frame. The association response frame is a management frame that contains information describing the access point, such as its capability and supported rates. The association response frame also includes an association ID (AID) that is assigned by the access point to identify the terminal device for delivery of buffered frames. The AID field is a value assigned by the access point during association, which represents the 16-bit ID of a terminal device. The length of the AID field is two octets, the value assigned as the AID is in the range 1-2007, and it is placed in the 14 lowest significant bits (LSBs) of the AID field, with the two most significant bits (MSBs) of the AID field each set to “1”.

An access point may maintain a polling list for use in selecting terminal devices in its network, which are eligible to receive contention free polls (CF-Polls) during contention free periods. The polling list is used to force the polling of contention free terminal devices capable of being polled, whether or not the access point has pending traffic to transmit to those terminal devices.

Whenever an access point needs to poll a group of terminal devices who already know their respective AIDs within the network that the access point manages, a contention free (CF) group poll message may be sent by the access point, having the following frame structure shown in Table 1:

TABLE 1
CF Group Poll frame structure

| Information | | | | |
|---|---|---|---|---|
| element | Frame Control | DA | TA | BSSID |
| | | Destination | MAC ID of AP | BSSID of network |
| | | Address (BC/MC) | | |
| Bits (octs) | 32 (4) | 48 (6) | 48 (6) | 48 (6) |

| Information | | | Transmit power | Target power for |
|---|---|---|---|---|
| element | Number Groups | Group ID | of AP | ACK |
| | Number of groups | ID of group polled | Transmit power | Target power for |
| | polled by this | | class of AP | ACK messages |
| | probe (N) | | | |
| Bits | 3 | N × 8 (N) | 4 | 4 |

| Information | Next probe for | | |
|---|---|---|---|
| element | group | Next L probes | CRC |
| | Group will be | ID of group polled | Cyclic redundancy |
| | polled again in K | in next L intervals | check |
| | intervals | | |
| Bits | N × 8 (N) | 8 + N × L × 8 | 32 (4) |
| | | (1 + N * L) | |

After receiving contention free (CF) group poll message from the access point, a terminal device in the group that has data to send, transmits a response message or acknowledgement (ACK) to access point, after waiting for a short interframe space (SIFS) interval.

The access point (AP) in an infrastructure BSS assists those mobile wireless devices (STAs) attempting to save power. The legacy IEEE 802.11e Wireless LAN standards provides for support of low power operation in handheld and battery operated STAs, called automatic power save delivery (APSD). A STA capable of APSD and currently in the power saving mode, will wake up at predetermined beacons received from the AP to listen to a Traffic Indication Map (TIM). If existence of buffered traffic waiting to be sent to the STA may be signaled through the TIM, the STA will remain awake until AP sends out all the data. The STA does not need to send a polling signal to the AP to retrieve data, which may be the reason for the term “automatic” in the acronym APSD.

A Traffic Indication Map (TIM) is a field transmitted in beacon frames, used to inform associated wireless terminal devices or STAs that the access point has buffered data waiting to be transmitted to them. Access points buffer frames of data for STAs while they are sleeping in a low-power state. The access point transmits beacons at a regular interval, the target beacon transmission time (TBTT). The Traffic Indication Map (TIM) information element in the periodically transmitted beacon frame, indicates which STAs have buffered data waiting to be accessed in the access point. Each frame of buffered data may be identified by an association identifier (AID) associated with a specific STAs. The AID may be used to logically identify the STAs to which buffered frames of data are to be delivered. The traffic indication map (TIM) contains a bitmap, with each bit relating to a specific association identifier (AID). When data is buffered in the access point for a particular association identifier (AID), the bit is “1”. If no data is buffered, the bit for the association identifier (AID) is “0”. Wireless terminal devices must wake up and listen for the periodic beacon frames to receive the Traffic Indication Map (TIM). By examining the TIM, a STAs may determine if the access point has buffered data waiting for it. To retrieve the buffered data, the STAs may use a power-save poll (PS-Poll) frame. After transmitting the PS-Poll frame, the client mobile station may stay awake until it receives the buffered data or until the bit for its association identifier (AID) in the Traffic Indication Map (TIM) is no longer set to “1”, indicating that the access point has discarded the buffered data.

Two variations of the APSD feature are unscheduled automatic power save delivery (U-APSD) and scheduled automatic power save delivery (S-APSD). In U-APSD, the access point (AP) may be always awake and hence a mobile wireless device (STA) in the power save mode may send a trigger frame to the AP when the STA wakes up, to retrieve any queued data at the AP. In S-APSD, the AP assigns a schedule to a STA and the STA wakes up, sends a power save poll packet to the AP in order to retrieve from the AP any data queued. An AP may maintain multiple schedules either with the same STA or with different STAs in the infrastructure BSS network. Since the AP may be never in sleep mode, an AP will maintain different scheduled periods of transmission with different STAs in the infrastructure BSS network to ensure that the STAs get the maximum power savings.

The IEEE 802.11ah WLAN standard operating below 1 GHz, has a greater range and lower obstruction losses due to its longer wavelength. IEEE 802.11ah provides wireless LAN operation in the sub-1 GHz range considered appropriate for sensor networks, machine-to-machine, cellular offload, and smart grid applications. IEEE 802.11ah defines three use case categories:

Use Case 1: Sensors and meters;

Use Case 2: Backhaul sensor and meter data; and

Use Case 3: Extended range Wi-Fi

A principal application of IEEE 802.11ah may be sensor networks, for example in smart metering, where the measurement information at each sensor node may be transmitted to an access point. In example sensor applications, the data packet size may be a few hundred bytes, the sensors may have a low duty-cycle, transmitting data every few minutes, and the number of sensor devices may be as large as 6000 devices communicating with an access point.

The IEEE 802.11ah WLAN standard organizes the STAs associated to a network, into groups. The association response frame transmitted by the access point device, indicates the group ID, along with the conventional association ID (AID) field that associates the STA to the access point. The group IDs may be numbered in descending order of group priority for quality of service (QoS) STAs. The access point may base its group ID number for the case of non-QoS STAs on their respective association times. In this manner, the access point may determine which STAs are members of which group. Based on the association request frame from a new requesting STA, the access point either uses QoS parameters or non-QoS parameters, such as proximity, to decide to which group the new STA is a member. The corresponding group ID of the group to which the new STA is assigned may be then sent by the access point to the STA in response to the association request message. The association response frame indicates the group ID, along with the conventional AID field that associates the STA to the access point.

The IEEE 802.11ah WLAN standard includes Synchronized Distributed Coordination Function (DCF) uplink channel access by STAs. The association response frame transmitted by the access point, defines a restricted access period, referred to as a restricted access window (RAW). Each restricted access window comprises multiple time slots and each time slot may be allocated to STAs paged in the traffic indication map (TIM). Uplink data transmissions, such as PS-polling operations, may be facilitated by transmitting the packet in a time slot in an uplink restricted access window. Downlink data transmission may be facilitated by the transmission of data packets in a downlink restricted access window. An example procedure for uplink channel access may include:
An awakened STA that decodes the beacon, sends a PS-Poll packet when its traffic indication map (TIM) bit may be set to one;
The STA may determine its channel time slot in an uplink restricted access window based on its AID bit position in the traffic indication map (TIM);
The STA may contend for access to the time slot with other STAs in the same group;
After resolving PS-Polls from STAs, the access point broadcasts a downlink allocation packet that may be positioned after the uplink restricted access window and before the downlink restricted access window, which includes a Block ACK, the duration of downlink restricted access window, and/or allocated downlink time slot for the STAs.

The access point includes in its transmitted beacon frame, a Grouping Parameter Set information element to inform the STAs within a group of [1] the interval they may sleep before they may contend for the medium and [2] their medium access duration. The Grouping Parameter Set element may include: [1] the group ID; [2] a prohibition interval; and [3] a group interval end time. The group interval end time, as the name implies, specifies the instant following the start of the beacon, at which the uplink restricted access window terminates, which applies to all STAs in the relevant group. The prohibition interval specifies the interval from the group's end time to its next start time at which members of the group are allowed to contend for the radio medium. The Grouping Parameter Set information element in the beacon frame enables the access point to place a given STA in one group in one beacon frame and move that STA to another group in the next consecutive beacon frame.

B. Overlapping BSS Coordination Of Macro/Pico Wi-Fi Networks

In sensor networks and smart grid applications, large numbers of wireless terminals or STAs, both fixed and mobile, arrayed over kilometer-sized areas, will need to communicate with a long-range access point device. In the case of IEEE 802.11 ah networks, it may be envisioned to have a Wi-Fi network of 6000 wireless terminal devices or STAs being served by a long-range access point. The STAs may operate on battery power and must conserve their power during long periods of inactivity punctuated by short durations of communication sessions.

The need to offload cellular telephone traffic onto local WiFi networks has increased with the growth of Internet data traffic going through mobile networks. Smart phone devices and laptops possessing Wi-Fi capabilities together with large screens and different Internet applications, have become a major source mobile data traffic. In the case of IEEE 802.11ah networks, it may be envisioned to have a short-range access point at an interface with a cellular telephone network, distributing Internet, sensor and other data traffic for a household, an apartment house, or a city block, for example, to STAs being served by the short-range access point.

In accordance with an example embodiment of the invention, where both the short-range and long-range Wi-Fi networks overlap in their operating channels, the two networks are able to coexist seamlessly with minimum performance degradation to either of the networks. In accordance with an example embodiment of the invention, MAC layer enhancements enable the performance enhancements in both long and short-range 802.11ah Wi-Fi networks.

Typically, an access point transmits a polling message or probe signal to the wireless terminal devices or STAs in a network managed by the access point. The basic idea of this polling message may be to inquire whether wireless client devices in a group have packets to transmit to the access point. Based on the received polling message, the STAs respond with a response message or an acknowledgement (ACK). The response message may provide information to the access point about the class of traffic, including a coarse estimate of the amount of data traffic allocation required by the polled STAs.

In networks having large numbers of STAs, both fixed and mobile, which need to respond to a polling message from the access point, bursts of high traffic volume may occur when many response messages are transmitted in substantially the same interval, causing significant delays due to collisions as the client devices compete for access to the wireless medium to transmit their responses.

FIG. 1 is an example coexistence scenario among long-range and short-range IEEE 802.11ah networks having overlapping basic service sets (BSSs), according to an example embodiment of the invention. In FIG. 1, AP#1 operates in the long-range 802.11ah basic service set (BSS), typically a wireless sensor network. The other four Aps, AP#2, AP#3, AP#4, and AP#5, operate in offloading short-range BSSs that are not mutually overlapping, while individually overlapping with the long-range AP#1. Any downlink packet transmitted from AP#1 to its associated STAs may collide with simultaneous packet exchanges in any of the short-range overlapping BSSs (OBSSs). Collisions result in re-transmissions and thereby, increased power consumption of battery-powered sensor STAs in the long-range network and reduced throughput in the long-range network. On the other hand, simultaneous transmissions in both BSSs may result in degradation of average throughput of the short-range, high data rate offloading BSS when its associated STAs or the AP may be in proximity to nodes in the long-range BSS. In accordance with an example embodiment of the invention, packet exchanges are protected within each BSS by quieting or avoiding transmissions the other BSS.

FIG. 2 is an example typical scenario of packet collision due to overlapping networks operating on the same channel. The short-range access point transmits downlink traffic up until the time T1. The short-range stations and access point are quiet during the interval from T1 until T2, during which the long-range sensor stations in the overlapping long-range network transmit uplink traffic. After the time T2, the short-range stations and access point may resume their transmissions. However, since the time T2 may be not known to the long-range sensor stations, they may continue their uplink transmissions, which may collide with the transmissions of the overlapping the short-range stations and access point.

In accordance with an example embodiment of the invention, in order to counteract the performance degradation (either in throughput or in power consumption) in an overlapping coexistence scenario, the overlapping network may be quiet or avoids transmissions while uplink or downlink transmissions are ongoing within the BSS. In order to prevent transmission in the overlapping BSS (OBSS), the AP in the OBSS needs to be informed in one embodiment by a control frame, about the restrictive transmission phase in the BSS. Based on the duration field in the received control message, the AP may ensure no communications occur within the OBSS. In another embodiment the information is conveyed in the beacon frame. The information may be explicitly directed to an overlapping BSS or it may be implicitly determined from restricted access windows or periodic restricted access windows contained in the beacon.

In accordance with an example embodiment of the invention, a new type of the conventional Clear-to-Send (CTS) control frame has been defined in IEEE 802.11ah, referred to herein as Broadcast CTS (B-CTS), in order to quiet the overlapping BSS (OBSS) network. The new CTS frame may be transmitted by the short-range AP within the BSS of the short-range network. An operating assumption may be that the Broadcast CTS (B-CTS) control frame may be also received by the long-range AP of the overlapping BSS (OBSS). The properties of this new Broadcast CTS (B-CTS) frame include: (a) it may be not transmitted as a unicast message but as a broadcast frame, and; (b) uniqueness in the purpose that may be two fold: (i) to enable not just one STA, but all awakened STAs within the short-range BSS to contend for the channel simultaneously and (ii) to quiet the long-range network that receives this frame from the short-range AP.

In conventional CSMA-CA based medium access, a STA with buffered uplink data transmits a request-to-send (RTS) frame to the AP. The AP responds with a clear-to-send (CTS) frame granting medium access for data transfer with reduced hidden node problem. Therefore, the CTS frame usually quiets the STAs in the BSS, except for the STA requesting medium access. A conventional CTS frame, in its MAC header, consists of Frame Control, receiver address (RA), and Duration fields. The Type and Sub-type sub-fields in the Frame Control that indicate a CTS frame are 01 and 1100, respectively. The RA field may be set to be identical to the transmitter address (TA) field in the previously transmitted RTS frame. Hence, a conventional CTS frame may be always transmitted to a specific STA.

In accordance with an example embodiment of the invention, when there is an overlapping BSS (OBSS) scenario, a broadcast clear-to-send (B-CTS) frame may be transmitted by the short-range AP in order to quiet the overlapped long-range AP. The B-CTS frame may be not sent in response to a RTS frame, but may be sent by the short-range AP to clear away interfering traffic from the overlapped long-range BSS. The long-range AP must be quiet, since downlink traffic and acknowledgements to any of its associated long-range sensor STAs may interfere with ongoing transmissions from or to a short-range STA within the short-range BSS that are in proximity to long-range STAs in the long-range overlapped BSS.

In accordance with an example embodiment of the invention, the other purpose of the broadcast clear-to-send (B-CTS) frame may be to grant medium access for a specific duration to all active short-range STAs in the short-range BSS, right after the end of the transmission of the B-CTS frame. This may be accomplished by using the broadcast address in the MAC header of the B-CTS frame. After the B-CTS frame transmission by the short-range AP, all active short-range STAs are allowed to contend for the medium using the conventional back-off parameters.

FIG. 3 is an example MAC header frame format of the broadcast clear-to-send (B-CTS) transmission time coordination frame 11, according to an example embodiment of the invention. Two or more of the short-range access points AP#2 and AP#3 may transmit a broadcast clear-to-send control frame (B-CTS) 10 and 10′, as shown in FIG. 4D. The B-CTS 10 sent by AP#2 notifies the long-range access point AP#1 of a second quiet interval ΔT for the long-range sensor stations STA1a, STA1b, STA1c associated with the long-range access point AP#1. The second occurring B-CTS 10′ sent by AP#3 notifies the long-range access point AP#1 that at least two short-range access points, AP#3 and AP#2, are attempting to reserve substantially the same second quiet interval ΔT. In accordance with an example embodiment of the invention, the long-range access point AP#1 may determine that it may be beneficial to coordinate the timing of the broadcast clear-to-send (B-CTS) to be sent by the short-range access points AP#2 and AP#3. The long-range access point AP#1 may send a B-CTS transmission time coordination frame 11 to the short range access points AP#2 and AP#3, as shown in FIG. 4E. The frame 11 allocates a first coordinated quiet interval Δ1 to the first overlapping short-range network BSS#2 and allocates a second coordinated quiet interval Δ2 to the second overlapping short-range network BSS#3. In this manner, the long-range access point AP#1 may provide some upper level coordination and synchronization of the short-range access points AP#2 and AP#3, to avoid having the overlapping short-range networks from taking excessive portions of air time. In one embodiment the long-range access point may allocate the coordinated quiet intervals Δ1 and Δ2 to occur at the same time. In an example embodiment of the invention, the long-range access point AP#1 may send individual B-CTS transmission time coordination frames to the short range access points AP#2 and AP#3 in both overlapping short-range networks BSS#2 and BSS#3.

An example MAC header frame format of the broadcast clear-to-send (B-CTS) transmission time coordination frame 11 is shown in FIG. 3. The example fields may be as follows:

302: Options;

304: Inactivity of long range AP indicates that BSS of long-range AP will be inactive during proposed B-CTS transmission times even if no B-CTS may be received;

306: B-CTS sent from long-range to short range AP indicates the intention of the long range AP to send a periodic B-CTS during the times defined in the frame;

308: Reserved;

310: Duration of B-CTS in microseconds (blanking period);

312: Target B-CTS transmission time in multiples of 32 us (time when short range AP should transmit their B-CTS) 41;

314: Target B-CTS transmission time in multiples of 32 us (time when short range AP should transmit their B-CTS) 42; and

316: Address of sending access point.

FIG. 4A is an example network diagram of a long-range IEEE 802.11ah network BSS#1 and two short-range IEEE 802.1 lah networks BSS#2 and BSS#3 that overlap the long-range network BSS#1. The figure shows the long-range access point AP#1 of the long range network BSS#1, monitoring the beacons 2 and 3 from the respective short-range access points AP#2 and AP#3. The monitoring may be done in order to schedule protected frame transmissions from the long-range sensor stations STA#1a, STA#1b, and STA#1c, associated with the long-range access point AP#1, between an instant T1 and an instant T2, according to an example embodiment of the invention. Similarly, the short-range access points AP#2 and AP#3 of the short range networks BSS#2 and BSS#3, may monitor the beacon from the long range network BSS#1.

FIG. 4B is an example network diagram of the long-range IEEE 802.11ah network BSS#1 and the two overlapping short-range IEEE 802.11ah networks BSS#2 and BSS#3 of FIG. 4A. The figure shows the long-range access point AP#1 transmitting a beacon 4 indicating the beginning instant T1 and the ending instant T2 of a first quiet interval (T1,T2). The quiet interval may be for the short-range stations STA#2a, STA#2b, and STA#2c, associated with the short-range access point AP#2. The quiet interval may be for STA#3a, STA#3b, and STA#3c associated with the short-range access point AP#3. These stations are in the two overlapping short-range networks BSS#2 and BSS#3. The long-range beacon 4 may be received by the long-range sensor stations STA#1a, STA#1b, and STA#1c, associated with the long-range access point AP#1. The long-range beacon 4 may indicate to the long-range sensor stations that they may access the medium between the instant T1 and the instant T2. The figure shows each of the long-range sensor stations STA#1a, STA#1b, and STA#1c recognizing that it may contend for the medium during the interval (T1,T2), according to an example embodiment of the invention.

In accordance with an example embodiment of the invention, the beacon 4 may be also received by the short-range access point AP#2, the short-range stations STA#2a, STA#2b, and STA#2c, the short-range access point AP#3, and short-range stations STA#3a, STA#3b, and STA#3c. The beacon 4 may indicate to them the first quiet interval (T1,T2) for the short-range stations STA#2a, STA#2b, and STA#2c, associated with the short-range access point AP#2 and STA#3a, STA#3b, and STA#3c, associated with the short-range access point AP#3 in the two overlapping short-range networks BSS#2 and BSS#3. The figure shows each of the short-range access points AP#2 and AP#3 recognizing that the short-range stations in the respective BSS#2 and BSS#3 must remain quiet during the interval (T1,T2), according to an example embodiment of the invention. The figure shows each of the short-range stations in BSS#2 and BSS#3 recognizing that it must remain quiet during the interval (T1,T2), according to an example embodiment of the invention.

FIG. 4C is an example network diagram of the long-range IEEE 802.11ah network BSS#1 and the two overlapping short-range IEEE 802.11ah networks BSS#2 and BSS#3 of FIG. 4B. The figure shows the short-range access point AP#2 and the short-range access point AP#3, respectively transmitting beacons 5 and 6, at their respective target beacon transmission times. These beacons may be scheduling the beginning instant T1 and the ending instant T2 of the first quiet interval (T1,T2) for the respective short-range stations STA#2a, STA#2b, and STA#2c, associated with the short-range access point AP#2 and STA#3a, STA#3b, and STA#3c, associated with the short-range access point AP#3 in the respective, two overlapping short-range networks BSS#2 and BSS#3. The figure shows each of the short-range stations in BSS#2 and BSS#3 recognizing that it must remain quiet during the interval (T1,T2), according to an example embodiment of the invention.

In accordance with an example embodiment of the invention, the two short-range access points AP#2 and AP#3 may further schedule restricted access windows (RAWs) or periodic restricted access windows (PRAW) of multiple time slots for uplink data transmissions and downlink data transmissions in the two, respective, overlapping short-range networks BSS#2 and BSS#3, according to an example embodiment of the invention. The long range access point AP#1 may transmit beacons with RAW and PRAW. Instead of explicit frames, the short range networks may also use the silent intervals in the beacon frame of the long range network to coordinate the transmissions in the short range network.

FIG. 4D is an example network diagram of the long-range IEEE 802.11ah network BSS#1 and the two overlapping short-range IEEE 802.11ah networks BSS#2 and BSS#3 of FIG. 4C. The figure shows two or more of the short-range access points AP#2 and AP#3 transmitting a broadcast clear-to-send control frame (B-CTS) 10 and 10′. B-CTS Frames 10 and 10′ notify the long-range access point AP#1 of a second quiet interval ΔT for the long-range sensor stations STA1a, STA1b, STA1c, associated with the long-range access point AP#1. The second occurring B-CTS 10′ sent by AP#3 notifies the long-range access point AP#1 that at least two short-range access points, AP#3 and AP#2, are attempting to reserve substantially the same second quiet interval ΔT. In accordance with an example embodiment of the invention, the long-range access point AP#1 determines that it may be beneficial to coordinate the timing of the B-CTS 10 and 10′ to be sent by the short-range access points AP#2 and AP#3. In this manner, the long-range access point AP#1 may provide some upper level coordination and synchronization of the short-range access points AP#2 and AP#3, to avoid having the overlapping short-range networks from taking excessive portions of air time.

FIG. 4E is an example network diagram of the long-range IEEE 802.11ah network and the two overlapping short-range IEEE 802.11ah networks of FIG. 4C. The figure shows the long-range access point AP#1 sending a B-CTS transmission time coordination frame 11 to the short range access points AP#2 and AP#3. FIG. 3 is an example MAC header frame format of the broadcast clear-to-send (B-CTS) transmission time coordination frame 11. The frame 11 allocates a first coordinated quiet interval Δ1 to the first overlapping short-range network BSS#2 and allocates a second coordinated quiet interval Δ2 to the second overlapping short-range network BSS#3, according to an example embodiment of the invention. The long-range AP may also use the B-CTS transmission time coordination frame 11 to indicate the intention of sending periodic B-CTS frames to the short range networks BSS#2 and BSS#3 to silence the short range networks. The short range networks BSS#2 and BSS#3 may use this information to coordinate, for example, beacon transmissions, target wake times, and periodic restricted access windows to occur outside of the time interval reserved by the B-CTS of the long range access point AP#1. The short range access points AP#2 and AP#3 may receive a subset of the beacon frames of the long range access point AP#1, to keep their clocks synchronized. The B-CTS transmission time coordination frame 11 may be sent as a control frame or a management frame to the short range access points AP#2 and AP#3. 4. The B-CTS transmission time coordination frame 11 may further indicate time restrictions for reserving the wireless medium for either one or both of the short range access points AP#2 and AP#3 and still other access points in other overlapped access networks.

FIG. 4F is an example network diagram of the long-range IEEE 802.11ah network and the two overlapping short-range IEEE 802.11ah networks of FIG. 4C. The figure shows the first overlapping short-range network BSS#2 exchanging traffic 13 during the first coordinated quiet interval Δ1, according to an example embodiment of the invention. The short range access points AP#2 and AP#3 may change their beacon transmission times for their respective beacons to be transmitted outside of the time restriction imposed by the B-CTS transmission time coordination frame 11.

FIG. 4G is an example network diagram of the long-range IEEE 802.11ah network and the two overlapping short-range IEEE 802.11ah networks of FIG. 4C. The figure shows the second overlapping short-range network BSS#3 exchanging traffic 13′ during the second coordinated quiet interval 42, according to an example embodiment of the invention. In an example embodiment of the invention, the first and second quiet intervals Δ1 and Δ2 may be the same, for example where the short range networks may operate at the same time since they may not interfere with each other.

FIG. 5 is an example flow diagram 700 of operational steps in the wireless short-range access point device, according to an example embodiment of the invention. The steps of the flow diagram represent computer code instructions stored in the RAM and/or ROM memory of the wireless device A, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 702: receiving, by an access node of an access network, a frame from an overlapped access network, indicating time restrictions for reserving a wireless medium for the access network; and

Step 704: coordinating, by the access node of the access network, transmissions by members of the access network, to comply with the time restrictions for reserving the wireless medium for the access network.

FIG. 6 is an example flow diagram 740 of operational steps in the wireless long-range access point device, according to an example embodiment of the invention. The steps of the flow diagram represent computer code instructions stored in the RAM and/or ROM memory of the wireless device A, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 742: receiving, by an access node of an access network, two or more frames from overlapped access networks; and

Step 744: transmitting, by the access node of the access network, a time coordination frame, indicating time restrictions for reserving a wireless medium for the overlapped access networks.

FIG. 7 is an example functional block diagram, illustrating an example long-range STA#1a, according to an example embodiment of the invention. The long-rang stations STA#1a, STA#1b, and STA#1c and the short-range stations STA#2a, STA#2b, and STA#2c, and STA#3a, STA#3b, and STA#3c, may have similar components, except for their particular applications. The short-range stations STA#2a, STA#2b, and STA#2c and STA#3a, STA#3b, and STA#3c may include an application to offload cellular telephone network traffic exchanged with respective short-range access points AP#2 and AP#3, for carrying by local WiFi networks. The long-rang stations STA#1a, STA#1b, and STA#1c may include sensors for smart metering, where the measurement information at each sensor node may be transmitted to a long-range access point AP#1.

The example STA#1a may include a processor 134 that may include a dual or multi-core central processing unit CPU_{—}1 and CPU_{—}2, a RAM memory, a ROM memory, and an interface for a keypad, display, and other input/output devices. The example STA#1a may include a protocol stack, including the transceiver 128 and IEEE 802.11 MAC 142, which may be based, for example, on the IEEE 802.11ah WLAN standard. The protocol stack may also include a network layer 140, a transport layer 138, and an application program 136.

In an example embodiment, the interface circuits in FIG. 7 may interface with one or more radio transceivers, battery and other power sources, key pad, touch screen, display, microphone, speakers, ear pieces, camera or other imaging devices, etc. The RAM and ROM may be removable memory devices 126 such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 9, may be based on magnetic, electronic and/or optical technologies. Examples of removable storage media 126 include magnetic disks, optical disks, semiconductor memory circuit devices and micro-SD memory cards (SD refers to the Secure Digital standard). The removable storage media 126 may store data and/or computer program code as an example computer program product, in accordance with at least one embodiment of the present invention.

FIG. 8 is an example functional block diagram, illustrating an example long-range access point AP#1, according to an example embodiment of the invention. The long-rang access point AP#1 and the short-range access point AP#2 and AP#3 may have similar components, except for their particular applications. The short-range access points AP#2 and AP#3 may include an interface to a cellular telephone network to offload cellular telephone network traffic, for transfer to their respective, associated short-range stations STA#2a, STA#2b, and STA#2c and STA#3a, STA#3b, and STA#3c for carrying by local WiFi networks. The long-rang access point AP#1 may include an application for forwarding sensor data, where the measurement information received from long-rang sensor stations STA#1a, STA#1b, and STA#1c, may be forwarded for further processing of the sensor data.

The example access point AP#1 may include a processor 134″ that may include a dual or multi-core central processing unit CPU_{—}1 and CPU_{—}2, a RAM memory, a ROM memory, and an interface for a keypad, display, and other input/output devices. The example access point AP#1 may include a protocol stack, including the transceiver 128″ and IEEE 802.11 ah MAC 142″, which may be based, for example, on the IEEE 802.11ah WLAN standard. The protocol stack may also include a network layer 140″, a transport layer 138″, and an application program 136″.

In an example embodiment, the interface circuits in FIG. 8 may interface with one or more radio transceivers, battery and other power sources, key pad, touch screen, display, microphone, speakers, ear pieces, camera or other imaging devices, etc. The RAM and ROM may be removable memory devices 126″ such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 9, may be based on magnetic, electronic and/or optical technologies. Examples of removable storage media 126 may include magnetic disks, optical disks, semiconductor memory circuit devices and micro-SD memory cards (SD refers to the Secure Digital standard). The removable storage media 126 may store data and/or computer program code as an example computer program product, in accordance with at least one embodiment of the present invention.

FIG. 9 illustrates an example embodiment of the invention, wherein examples of removable storage media 126 are shown. The removable storage media are based on magnetic, electronic and/or optical technologies, such as magnetic disks, optical disks, semiconductor memory circuit devices and micro-SD memory cards (SD refers to the Secure Digital standard). The removable storage media 126 are for storing data and/or computer program code as an example computer program product, in accordance with at least one embodiment of the present invention.

In an example embodiment of the invention, wireless networks may include other sensor type networks and/or other networks having a large number of supported stations/apparatuses. Examples of such networks include, for example cellular systems such as Global System for Mobile Communications (GSM), Wideband Code Division Multiple Access (W-CDMA), High Speed Packet Access (HSPA), Long Term Evolution (LTE), LTE Advanced (LTE-A), International Mobile Telecommunications Advanced (IMT-A), CDMA, Wireless Metropolitan Area Networks (WMAN) and Broadband Wireless Access (BWA) (LMDS, WiMAX, AIDAAS and HiperMAN), or the like networks. Examples of such networks include, for example, short-range networks such as Bluetooth, Zigbee, IEEE 802.11, Digital Enhanced Cordless Telecommunications (DECT), HiperLAN, Radio Frequency Identification (RFID), Wireless USB, DSRC (Dedicated Short-range Communications), Near Field Communication, wireless sensor networks, EnOcean; TransferJet, Ultra-wideband (UWB from WiMedia Alliance), WLAN, WiFi, and HiperLAN.

In accordance with an example embodiment of the invention, the STAs 100 may be, for example, a miniature device such as a key fob, smart card, jewelry, or the like. The STAs 100 may be, for example, a larger device such as a cell phone, smart phone, flip-phone, PDA, graphic pad, or even larger devices such as a laptop computer, an automobile, and the like.

In an example embodiment of the invention, an apparatus comprises:

means for receiving, by an access node of an access network, a frame from an overlapped access network, indicating time restrictions for reserving a wireless medium for the access network; and

means for coordinating, by the access node of the access network, transmissions by members of the access network, to comply with the time restrictions for reserving the wireless medium for the access network.

In an example embodiment of the invention, an apparatus comprises:

means for receiving, by an access node of an access network, two or more frames from overlapped access networks; and

means for transmitting, by the access node of the access network, a time coordination frame, indicating time restrictions for reserving a wireless medium for the overlapped access networks.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments of the invention have been disclosed, a person skilled in the art will understand that changes can be made to the specific example embodiments without departing from the spirit and scope of the invention.

What is claimed is:

1. A method, comprising:
receiving, by an access node of an access network, a frame from an overlapped access network, indicating time restrictions for reserving a wireless medium for the access network; and
coordinating, by the access node of the access network, transmissions by members of the access network, to comply with the time restrictions for reserving the wireless medium for the access network.

2. The method of claim 1, wherein the access network and the overlapped access network are both basic service sets and the access node is an access point.

3. The method of claim 1, wherein the access network is a short range network and the overlapped access network is a long range network.

4. The method of claim 1, wherein the frame further indicates time restrictions for reserving the wireless medium for at least one of the overlapped access network and a third access network.

5. The method of claim 1, wherein reserving the wireless medium comprises reserving the wireless medium for one of a restricted access window for a subset of stations in the access network or a periodic restricted access window for a subset of stations in the access network.

6. The method of claim 1, wherein the frame is one of a broadcast clear-to-send frame or a broadcast clear-to-send coordination frame.

7. The method of claim 1, wherein the access node changes its beacon transmission time for its beacon to be transmitted outside of the time restrictions.

8. A method, comprising:
receiving, by an access node of an access network, two or more frames from overlapped access networks; and
transmitting, by the access node of the access network, a time coordination frame, indicating time restrictions for reserving a wireless medium for the overlapped access networks.

9. The method of claim 8, wherein the access network and the overlapped access networks are basic service sets and the access node is an access point.

10. The method of claim 8, wherein the access network is a long range network and the overlapped access networks are short range networks.

11. The method of claim 8, wherein the frame further indicates time restrictions for reserving the wireless medium for the access network.

12. The method of claim 8, wherein reserving the wireless medium comprises reserving the wireless medium for a restricted access window for a subset of sensor networks.

13. The method of claim 8, wherein the received frame is a broadcast clear-to-send frame.

14. The method of claim 8, wherein the transmitted time coordination frame is a broadcast clear-to-send frame.

15. An apparatus, comprising:
at least one processor;
at least one memory including computer program code;
the at least one memory and the computer program code configured to, with the at least one processor, cause the apparatus at least to:
receive a frame from an overlapped access network, indicating time restrictions for reserving a wireless medium for an access network of the apparatus; and
coordinate transmissions by members of the access network, to comply with the time restrictions for reserving the wireless medium for the access network.

16. The apparatus of claim 15, wherein the access network and the overlapped access network are both basic service sets and the access node is an access point.

17. The apparatus of claim 15, wherein the access network is a short range network and the overlapped access network is a long range network.

18. An apparatus, comprising:
at least one processor;
at least one memory including computer program code;
the at least one memory and the computer program code configured to, with the at least one processor, cause the apparatus at least to:
receive two or more frames from overlapped access networks; and
transmit a time coordination frame, indicating time restrictions for reserving a wireless medium for the overlapped access networks.

19. A computer program product comprising computer executable program code recorded on a computer readable, non-transitory storage medium, the computer executable program code comprising:
code for receiving, by an access node of an access network, a frame from an overlapped access network, indicating time restrictions for reserving a wireless medium for the access network; and
code for coordinating, by the access node of the access network, transmissions by members of the access network, to comply with the time restrictions for reserving the wireless medium for the access network.

20. A computer program product comprising computer executable program code recorded on a computer readable, non-transitory storage medium, the computer executable program code comprising:
code for receiving, by an access node of an access network, two or more frames from overlapped access networks; and
transmitting, by the access node of the access network, a time coordination frame, indicating time restrictions for reserving a wireless medium for the overlapped access networks.
